(19) United States
(12) Patent Application Publication
(10) Pub. No.: US 2015/0015518 A1
(43) Pub. Date: Jan. 15, 2015

(54) METHOD FOR DISPLAYING INFORMATION IN A VEHICLE INTERIOR

(71) Applicant: Audi AG, Ingolstadt (DE)

(72) Inventors: Björn Giesler, Gaimersheim (DE); Patrick Heinemann, Kösching (DE); Michael Schadeck, Ingolstadt (DE); Stefan Stümper, Eichstätt (DE)

(21) Appl. No.: 14/367,151

(22) PCT Filed: Dec. 17, 2012
(86) PCT No.: PCT/EP2012/005200

§ 371 Date: Jun. 19, 2014

(30) Foreign Application Priority Data
Dec. 20, 2011 (DE) 10 2011 121 617.4

(51) Int. Cl. B60K 37/06; B60K 35/00; G06F 3/041

(52) U.S. Cl. CPC B60K 37/06; G06F 3/041; B60K 35/00
USPC 345/173; 345/156

(57) ABSTRACT

In a method for displaying information in a vehicle interior by means of a display unit of a motor vehicle, wherein for the display of the information on the display unit extending in at least a horizontal direction, at least one horizontal subregion of the display unit having a smaller spatial extent than the display unit is determined by means of a user input, the position of said subregion on the display unit at least along the horizontal direction being predetermined by means of user input, wherein the at least one subregion is activated selectively for the display of the information.

The invention relates to a method for displaying information in a vehicle interior by means of a display device of a motor vehicle.

From the state of the art motor vehicles with driver assist systems, in particular infotainment systems, are known which combine comfort, safety and/or information functions. Hereby a digital street map is for example displayed as navigation aid on a central display device, which is for example integrated in an instrument panel or in a center console of the motor vehicle. The same display device is used for playing back media files such as movies, music titles or TV shows. For this purpose, the display device typically has means for outputting acoustic signals such as in particular loudspeakers.

For entertainment of passengers, multiple display devices can be provided which are for example integrated in rear regions of vehicle seats which are arranged in a front region of the motor vehicle.

It is further known to provide an interior of the motor vehicle with a subdued ambient illumination, wherein illuminating devices, which are configured for outputting the ambience, and which are in particular integrated in components of the interior lining of the motor vehicle and include for example multiple light-emitting diodes are provided. By means of the ambience output the interior of the motor vehicle is dimly illuminated in order to render the drive in the motor vehicle comfortable.

In light of this state of the art it is an object of the present invention to set forth an improved method for displaying information in the interior of the vehicle which can be comfortably and flexibly adjusted to the desires of the passengers.

This object is solved by a method of the aforementioned type, wherein for displaying the information on the display device which extends in at least one horizontal direction, a subregion of the display device, which has a smaller spatial extent than the display device, is defined by means of a user input, with a position of the subregion on the display device being predetermined by the user along at least the horizontal direction by means of the user input, wherein the at least one subregion is selectively controlled for displaying the information.

The display device can be configured by the user. For this in particular the spatial extent and the arrangement of the subregion provided for displaying the information can be freely predetermined by the user along the at least one horizontal direction. This allow passengers to utilize the display device for entertainment and/or informational purposes, wherein the position of the sub region which displays the information can be flexibly configured so that in particular a distraction of a driver during the drive is minimized. The passengers thus do not have to forego the output of entertainment media such as movies during the drive for reasons of driving safety.

For example the display device extends in horizontal direction over an entire vehicle width and is thus used by multiple passengers at the same time. In a preferred exemplary embodiment of the invention the display device extends in the front region of the vehicle interior over a region of a driver seat and a passenger seat. For displaying the information the driver and a passenger thus share the common display device. When for example the passenger wishes to watch a movie, the possibility to configure the display device in horizontal direction makes it possible that the corresponding media content is only outputted on the subregion of the display, which is assigned to the passenger seat. The region of the display device assigned to the driver seat remains unused. This achieves that the movie is played back outside the field of vision of the driver so that an adverse effect on the attention of the driver in particular during the drive is minimized. This increases the safety of the passengers which however do not have to forego entertainment during the drive.

In an advantageous exemplary embodiment of the invention the region of the display device, which is not used for the display of the information, is controlled so as to output an ambience. In the ambience output the vehicle interior is for example gently illuminated with light of low intensity. The gentle illumination of the vehicle interior with subdued light does not or only insignificantly adversely affect the attention of the driver. At the same time the subdued illumination of the interior of the vehicle by means of the ambience output enables in particular during night drives a comfortable adaption of he vision of the driver to the reduced visibility so that a premature fatigue can be avoided. The use of a display device for simultaneous display of information and for displaying the ambiance output additionally saves valuable construction space in the vehicle interior.

Particularly preferably, the display of the ambience output occurs in the form of a temporally adjustable pattern. For this the region of the display device which is unused during the display of the information is dynamically controlled.

For displaying further items of information in a further horizontal subregion of the display device this further subregion is determined by the user by a further user input. For this a position of the further subregion is predetermined at least along the horizontal direction. For displaying the further item of information the further subregion is correspondingly selectively controlled. The method for displaying the information enables using of the display device in many different ways in particular for the entertainment of the passengers. The information displayed in the subregion and the further information displayed in the further subregion of the display device can be predetermined by the user so that the display device can in particular be used by multiple passengers simultaneously for different purposes without compromising individual wishes. The method for displaying information is particularly suited to be implemented in a driver assist system or in an infotainment system of the motor vehicle. For example a media file can be outputted in a subregion assigned to a passenger seat, wherein at the same time driving instructions of a navigation system of the motor vehicle are outputted in the subregion assigned to the driver seat.

Preferably the user input and the further user input occurs via an input device, which is integrated in a touch sensitive display (touchscreen). This enables in particular the selecting the position of the subregion in an especially intuitive manner by means of corresponding finger movements. In addition such a configuration of the display device with integrated input device advantageously saves additional construction space in the vehicle interior which otherwise would have to be used for an external input device.

In a further exemplary embodiment the user input and/or the further user input occurs via a keyboard. As an alternative or in addition the user input and/or the further user input occurs by means of a voice recognition, so that in particular the driver can change the control of the display device during the drive in a particularly easy and simple manner.

Preferably the information and/or the further information is assigned to a media content, in particular to a play back of a movie or an audio file. It is thus provided that as information and/or as further information musical titles or performers of a currently played musical piece are outputted in the subregion or in the further subregion of the output device.

In a preferred exemplary embodiment of the invention, the vehicle receives a terrestrial or satellite based signal which contains the information and/or the further information. In particular TV shows and/or radio broadcasts can be received in this way. In the case of digital radio broadcasts the file which contains the media content is typically transmitted together with meta data which in particular contain information regarding the title of the musical piece or the performer.

Correspondingly the name of the performer or the title of the played musical piece is outputted during the playback as information and/or as further information.

Further, the object is solved by a motor vehicle, which is configured for carrying out the method according to the invention for displaying the information. The same as discussion as set forth with regard to the method applies correspondingly to the motor vehicle. The motor vehicle includes the at least one light-emitting display device which extends in horizontal direction, at least one input device provided for the user input and at least one control device which controls the display device. The input device is connected with the control device for detecting user inputs by the user so that the display of the information can be configured by the user. The subregion provided for displaying the information can be predetermined by the user. For example the display device has a user surface which allows configuring the subregion as rectangular window. The position and/or the extent of the window on the display device can be freely predetermined by the user.

In a preferred exemplary embodiment of the invention the horizontal direction in which the display device extends, extends parallel to the transverse axis of the vehicle. In an alternative exemplary embodiment the horizontal direction extends parallel to the longitudinal axis of the vehicle. Preferably the horizontal extent of the display device extends over multiple regions, which are assigned to different passengers. This enables multiple passengers to use the display device together. In the case of an orientation of the display device along the transverse axis of the vehicle it is in particular provided that the display device is used by the driver together with the passenger. In the case the display device extends along the longitudinal axis of the vehicle the display device can be used simultaneously by a passenger seated in a front region of the motor vehicle and by a passenger seated in the rear region of the motor vehicle. This advantageously saves valuable construction space.

In an exemplary embodiment, the display device is arranged so as to extend at least partially along a circumference vehicle interior. The display device configured in this way thus extends parallel to the transverse axis as well as the longitudinal axis of the vehicle. In particular in a motor vehicle, which is constructed as a passenger car this makes it possible that the majority of the passengers can use the display device for displaying information, the further information and/or for ambience output together. In particular the display device can be arranged in the region of a vehicle column such as an A-, B- or C-column.

Preferably the display device is configured band-shaped, i.e., it has a vertical extent which is significantly smaller than the horizontal extent. The display device is arranged adjacent the border of at least one vehicle window, in particular a windshield of the motor vehicle. The thus configured display device enables output of the information for example in the form of moving text in the subregion provided therefore. The display device is for example configured as window base display and is integrated in an inner panel, which is situated adjacent the a border of a windshield. The information displayed in the subregion of the display device is situated in the peripheral field of vision of the driver thereby minimizing a distraction of the driver by the display during the drive.

In a particularly preferred exemplary embodiment of the invention, the at least one input device provided for the user input is integrated in the display device as touch sensitive display. The touch sensitive display represents a haptic user interface which enables a particularly intuitive operation and configuration of the display device. For example the windows generated on the user surface of the display device and defining the subregion and the further subregion can be moved by means of a corresponding movement in particular in horizontal direction.

In a further advantageous exemplary embodiment of the invention, the motor vehicle has a receiving device, which is configured to receive the terrestrial or satellite-based signal. The receiving device is connected with the at least one control: device so that the information and/or the further information which is contained n the terrestrial or satellite based signal can be outputted by the motor vehicle. The receiving device is configured to receive digital signals and/or analog signals such as in particular digital and/or analog radio and/or TV signals.

Advantageously the display device additionally has means for outputting an acoustic signal so that the playback of media contents such as movies, audio files, musical pieces or the like is possible.

In an exemplary embodiment, the display device is configured as liquid crystal display device (LCD). The display device has an optical resolution which is suited for displaying movies TV shows or computer games.

Further advantages and details of the invention are explained in the following by way of exemplary embodiments and with reference to the drawings. It is shown in:

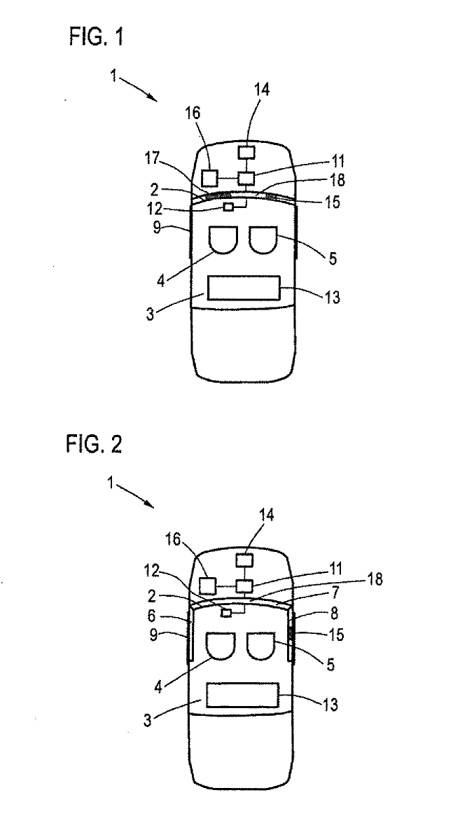

FIG. 1 a motor vehicle which is configured for carrying out the method according to the invention and has a display device which extends in horizontal direction over an entire width of the motor vehicle.

FIG. 2 a further exemplary embodiment of the motor vehicle with a display device which is arranged so as to extend partially along a circumference of the vehicle interior,

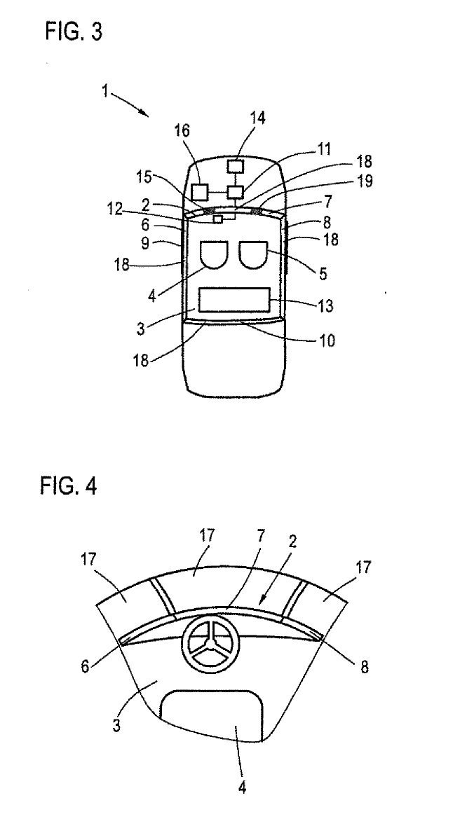

FIG. 3 a further exemplary embodiment of the motor vehicle with a display device which is arranged so as to extend along an entirety of a circumference of the vehicle interior, and

FIG. 4 a perspective view of a frontside region of the vehicle interior.

Corresponding parts are provided with the same reference numerals in all Figures.

FIG. 1 shows a motor vehicle 1, which has a display device 2 which extends parallel to a vehicle transverse axis in a horizontal direction over the entire width of the motor vehicle 1. The display device 2 is configured as liquid crystal display and arranged adjacent to a border of a windshield of the motor vehicle 1. The display device 2 extends over the entire width of the vehicle and thus over a region assigned to a driver seat 4 and over a further region assigned to a passenger seat 5. For displaying information the driver and the passenger thus share the common display device 2.

FIG. 2 shows a second exemplary embodiment of the motor vehicle 1, which has a display device 2, which extends parallel to the transverse axis of the vehicle as well as parallel to a longitudinal axis of the motor vehicle. Sections of the display device 2 are formed by three respective display elements 6, 7, 8, which are configured as displays. Two of these display elements 6, 8 extend partially over a width of a respective vehicle door 9.

FIG. 3 shows a third exemplary embodiment of the motor vehicle 1 wherein a display device 2 is provided which extends along the entirety of the circumference of the vehicle interior. Sections of the display device 2 are formed by display elements 6, 7, 8, 10.

The exemplary embodiments of the invention shown in the FIGS. 1 to 3 have respective control units 11 which are configured to control the respective display devices 2. The control unit 11 is connected with an input device 12 by means of which a user input by the user can be detected. In a not further shown manner multiple input devices 12 are provided which are correspondingly arranged in the regions of the vehicle seats 4, 5 and/or in the region of a rear bench 13 for detecting the user input.

In a preferred exemplary embodiment, the input device 12 is integrated in the display device 2 as touch sensitive display.

In an alternative exemplary embodiment the input device 12 is configured as a console which includes a keyboard.

In addition a voice recognition unit is provided in a not further shown manner, which has a voice recognition implemented as software, so that the user input or a further user input can be detected as acoustic signal.

A receiving device 14 is operably connected with the control unit 11. By means of the receiving unit 14 a terrestrial signal or a satellite-based signal can be detected which contains the information to be displayed. The thus received information can be outputted to a subregion 15 of the display device 2, wherein a corresponding control of the display device 2 occurs by means of the control unit 11.

Further, the control unit 11 is connected with a memory unit 16 on which for example media contents for example in the form of audio and movie files can be stored. The information, which is to be displayed in the subregion 15 can in particular be assigned to the media content. For this for example a performer and/or a title of a musical piece can be displayed simultaneously in the subregion 15 when the musical piece is played back. Correspondingly the display device 2 has in a not further shown manner means for outputting an acoustic signal so that the playback of the media contents is possible.

FIG. 4 shows a perspective view of a front side region of the vehicle interior 3. The display device 2, which is formed by the display elements 6, 7, 8 circumferentially extends partially along the vehicle interior 3. The display elements 6, 7, 8 are arranged at borders of vehicle windows 17. The display element 7 which forms sections of the display device 2 is situated in the field of vision of the driver so that information displayed there can be easily perceived by the driver if needed without the driver having to direct his view away from the driving direction to a significant degree.

In addition the display device 2 is configured for displaying an ambience output in which the vehicle interior 3 is gently illuminated with light of low intensity.

In a method for displaying the information in the vehicle interior 3 the subregion 15 is determined in a first method step by means of the user input by the user. The subregion 15 has a smaller spatial extent than the display device 2. The spatial extent of the subregion 15 and its spatial arrangement on the display device 2 is predetermined by means of the user input.

In an exemplary embodiment of the invention, a window is generated on the user surface of the display device 2 during the determination of the subregion 15 in which window the information is outputted in a second method step. The window can in particular be moved in horizontal direction thereby enabling minimizing distraction of the driver. The information to be displayed includes for example movies and/or computer games.

When the information is displayed an unused region 18 of the display device 2 remains which is controlled for displaying the ambience output. As ambience output a temporally changeable pattern such as a gentle wave pattern is outputted. For this the display device 2 is correspondingly dynamically controlled by the control unit 11.

Also the representation of the information in the subregion 15 can occur in a temporally changeable manner for example in the form of moving text.

In a possible exemplary embodiment of the method for displaying the information a digital street map is displayed in the region of the display device 2 assigned to the driver seat 4 as navigation aid. At the same time a further information is displayed in a further subregion 19 of the display device 2 which is assigned to the passenger seat 5, which further information corresponds to the display of a movie. The position and size of the further subregion 19 are determined by means of the further user input. The entire unused region 18 of the display device 2 is used simultaneously for outputting the ambience. The method for displaying the information is implemented within the framework of an infotainment system. The displayed information or the displayed further information can correspond to the playback of news tickers, weather information, podcast and/or media contents. The free configurability of the display in the subregion 15 or the further subregion 19 enables the common use of the display device 2 by multiple passengers, which can be seated correspondingly on the driver seat 4 the passenger seat 5 or the rear bench 13.

It is understood of course that the shown Figures merely illustrate the motor vehicle according to the invention and are not to be understood as limiting. Combinations of the individual exemplary embodiments are also within the scope of the present invention such as the display of different types of information in the subregion which for example are generated during the operation of a driver assist system configured as parking assistant, dead spot assistant, distance warner or pedestrian protection system.

What is claimed is:

1-15. (canceled)

16. A method for displaying information in an interior of a motor vehicle, comprising:
defining by a user input at least one horizontal subregion of a display device of the motor vehicle, said at least one horizontal subregion having a smaller spatial extent than the display device, said display device extending in at least one horizontal direction;
determining by the user input a position of the subregion at least along the horizontal direction; and
selectively controlling the at least one subregion for displaying the information.

17. The method of claim 16, wherein another region of the display device which is not used during the display of the information is controlled so as to display an ambience output.

18. The method of claim 17, wherein the region of the display device which is not used during the display of the information is dynamically controlled, in particular for displaying a temporally changeable pattern.

19. The method of claim 16, further comprising defining by a further user input a further horizontal subregion of the display device for displaying a further information wherein a position of the further subregion on the display device is predetermined along at least the horizontal direction and the further subregion is selectively controlled for displaying the further information.

20. The method of claim 16, wherein the information and/or the further information is assigned to a media content, in particular to a playback of a movie or an audio file.

21. The method of claim 16, further comprising receiving by the motor vehicle a terrestrial or satellite based signal, which contains the information and/or the further information for displaying the information and/or the further information,

22. A motor vehicle configured for carrying out the method of claim 16, comprising:
at least one light emitting display device extending in at least one horizontal direction;
at least one control unit controlling the display device; and
at least one input device connected with the control device and configured to detect of a user input.

23. The motor vehicle of claim 22, wherein the display device extends in plural horizontal directions with least one of the plural horizontal directions extending parallel to a transverse or longitudinal axis of the vehicle.

24. The motor vehicle of claim 22, wherein the display device is arranged so as to at least partially extend along a circumference of an interior of the motor vehicle.

25. The motor vehicle of claim 22, wherein the display device is arranged adjacent a border of at least one vehicle window, in particular a windshield.

26. The motor vehicle of claim 22, wherein the at least one input device is integrated in the display device as touch sensitive display.

27. The motor vehicle of claim 22, further comprising a receiving device for receiving a terrestrial or satellite based signal, said receiving device being connected with the at least one control unit.

28. The motor vehicle of claim 22, further composing a memory unit for storing media contents, said control unit being connected with the memory unit.

29. The motor vehicle of claim 24, wherein the display device comprises means for outputting an acoustic signal.

30. The motor vehicle of claim 24, wherein the display device is constructed as liquid crystal display device.
